(19) United States
(12) Patent Application Publication
(10) Pub. No.: US 2015/0049951 A1
(43) Pub. Date: Feb. 19, 2015

(54) PRESENTING MEANINGFUL INFORMATION SUMMARY FOR ANALYZING COMPLEX VISUALIZATIONS

(71) Applicant: International Business Machines Corporation, Armonk, NY (US)

(72) Inventors: Nitin Chaturvedi, Pune (IN); Nikhil Mayaskar, Pune (IN); Varun K. Mishra, Pune (IN)

(21) Appl. No.: 14/312,759

(22) Filed: Jun. 24, 2014

Related U.S. Application Data
(63) Continuation of application No. 13/967,797, filed on Aug. 15, 2013.

(51) Int. Cl. G06K 9/62

(52) U.S. Cl. CPC G06K 9/6217
USPC 382/190

(57) ABSTRACT

Machine logic that can display a visualization and also present a visualization summary. The visualization summary includes one or more of the following: (i) a guide for a user's interpretation of the visualization; (ii) a machine-logic generated interpretation of at least one portion of the visualization; and/or (iii) insight information based, at least in part, on the machine-logic generated interpretation of the visualization. The machine-logic based interpretation is based on rules that are applied based, at least in part, upon features and/or characteristics of the visualization.

### FIELD OF THE INVENTION

The present invention relates generally to the field of human understandable visual data presentation (for example, graphs).

### BACKGROUND OF THE INVENTION

The saying “a picture is worth a thousand words” refers to the notion that a complex idea and/or voluminous information can be conveyed with just a single still image. It is often an objective of visual images to convey information and/or insights derivable from information in a manner that is concise and clear. For purposes of this document, “visualization” is defined as any technique for creating images, diagrams, or animations to communicate information and/or insight derivable from the information. Examples from history of advances in the art and technology of visualization include cave paintings, Egyptian hieroglyphs, Greek geometry, and Leonardo da Vinci's revolutionary methods of technical drawing for engineering and scientific purposes. Moving to more recent times, some displays of charts or graphs will selectively display static information when a user moves a cursor over a particular predetermined area within the chart or graph. This selectively-displayed static information is based on the input data used to make the chart or graph and allows a user to “dig deeper” with respect to an area within the chart or graph that is relevant to the user's intellectual curiosity.

The complexity of data and information density of business-related visualizations has increased greatly (due to complex business scenarios) such that visualizations for presenting the information have often become very complex and difficult to interpret. For example, there are sometimes multiple charts representing the same data, in different ways, for depicting a particular business case. As a specific example of this, in some cases one chart presents sales volume over time and another chart presents price over time, and both charts need to be analyzed to make some meaningful conclusions such as to identify which stocks are volatile. The visualization for multiple parameters may also appear on a single chart, but the chart may become fairly complex due to huge amounts of data and/or complex business scenarios. Another example of a conventional, but complex, visualization is a finance chart such as those that present stock price variations for multiple indexes over a period of several years of activity.

### SUMMARY

According to an aspect of the present invention, there is a method of communicating information concerning a visualization. The method includes the following actions: (i) receiving graphical data corresponding to a visualization; (ii) generating a summary of the visualization; and (iii) presenting the summary of the visualization in human understandable form and format. The summary of the visualization includes at least one of the following: (i) a guide for a user in interpreting the visualization; (ii) a machine-logic generated interpretation of at least one portion of the visualization; and (iii) insight information based, at least in part, on a machine-logic generated interpretation of the visualization.

### BRIEF DESCRIPTION OF THE SEVERAL VIEWS OF THE DRAWINGS

FIG. 1 is a schematic view of a first embodiment of a computer system;

FIG. 2 is a flowchart showing a method performed, at least in part, by the first embodiment computer system;

FIG. 3 is a schematic view of a software program portion of the first embodiment computer system;

FIG. 4 is a screenshot generated by the first embodiment computer system;

FIG. 5A is another screenshot generated by an embodiment of the present disclosure;

FIG. 5B is another screenshot generated by an embodiment of the present disclosure;

FIG. 6 is another screenshot generated by an embodiment of the present disclosure;

FIG. 7 is another flowchart showing a method performed, at least in part, by an embodiment computer system;

FIG. 8 is another flowchart showing a method performed, at least in part, by an embodiment of the present invention; and

FIG. 9 is a bar chart for use with the present invention.

### DETAILED DESCRIPTION

This Detailed Description section is divided into the following sub-sections: (i) The Hardware and Software Environment; (ii) First Embodiment; (iii) Further Comments and/or Embodiments; and (iv) Definitions.

### I. The Hardware and Software Environment

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

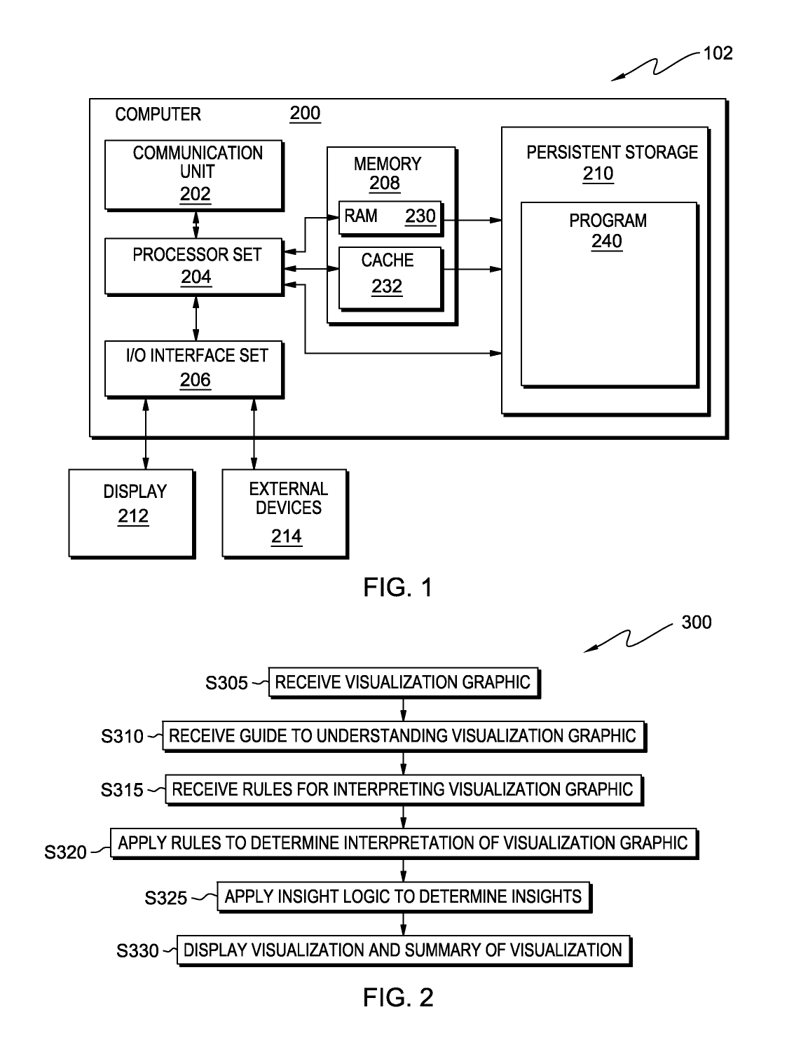

An embodiment of a possible hardware and software environment for software and/or methods according to the present invention will now be described in detail with reference to the FIG. 1. FIG. 1 is a functional block diagram illustrating various portions of computer system 102, including: computer 200; communication unit 202; processor set 204; input/output (i/o) interface set 206; memory device 208; persistent storage device 210; display device 212; external device set 214; random access memory (RAM) devices 230; cache memory device 232; and program 240. Several portions of computer system 102 will now be discussed in the following paragraphs.

Computer system 102 may be a laptop computer, tablet computer, netbook computer, personal computer (PC), a desktop computer, a personal digital assistant (PDA), a smart phone, or any programmable electronic device capable of communicating with remote computers via a communication network (not shown), such as the internet. Program 240 is a collection of machine readable instructions and/or data that is used to create, manage and control certain software functions that will be discussed in detail, below, in the First Embodiment sub-section of this Detailed Description section.

As shown in FIG. 1, computer system 102 is shown as a block diagram with many double arrows. These double arrows (no separate reference numerals) represent a communications fabric, which provides communications between various components of system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for system 102; and/or (ii) devices external to system 102 may be able to provide memory for system 102.

Program 240 is stored in persistent storage 210 for access and/or execution by one or more of the respective computer processors 204, usually through one or more memories of memory 208. Persistent storage 210: (i) is at least more persistent than a signal in transit; (ii) stores the device on a tangible medium (such as magnetic or optical domains); and (iii) is substantially less persistent than permanent storage. Alternatively, data storage may be more persistent and/or permanent than the type of storage provided by persistent storage 210.

Program 240 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to system 102 (not shown). In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 240, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. First Embodiment

Preliminary note: The flowchart and block diagrams in the following Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

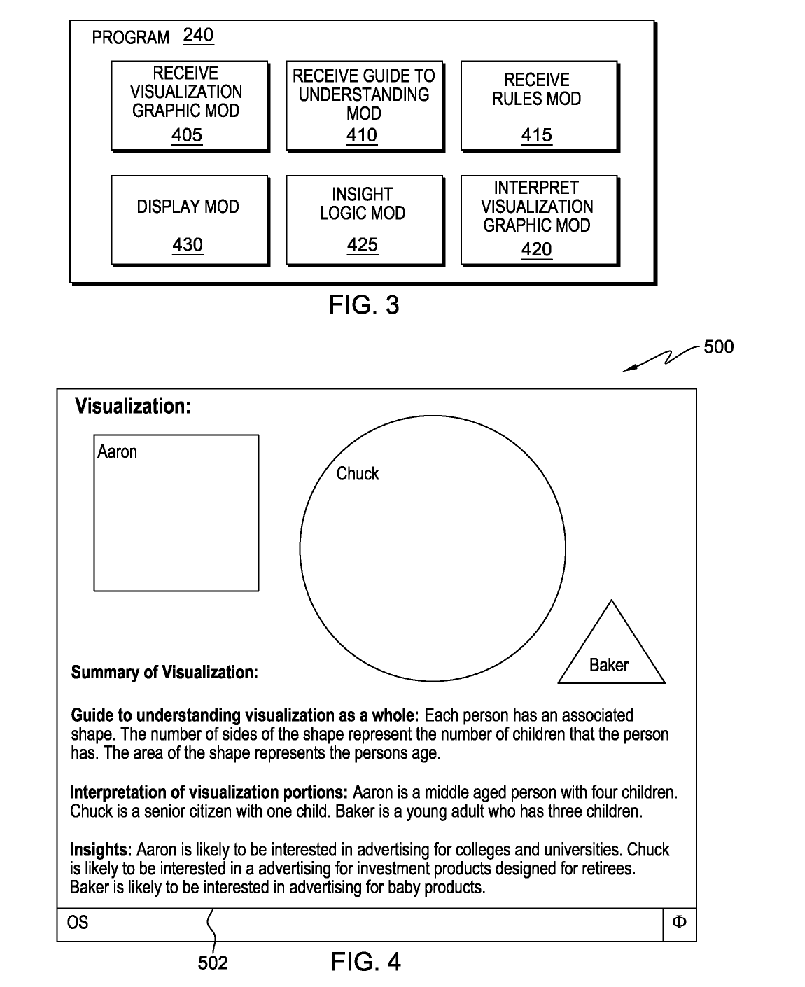

FIG. 2 shows a flow chart 300 depicting a method according to the present invention. FIG. 3 shows program 240 for performing at least some of the method steps of flow chart 300. This method and associated software will now be discussed, over the course of the following paragraphs, with extensive reference to FIG. 2 (for the method step blocks) and FIG. 3 (for the software blocks).

Processing begins at step S305 where receive visualization graphic module (“mod”) 405 receives graphical data that corresponds to a visualization. In this embodiment, the graphic data is a .jpg (that is, a known image format that allows for image compression) format bit map that corresponds color values for the various pixels in the image of the visualization. Alternatively, the graphic data may be another type of graphic data, such as raster based data. However, because the data is merely graphic data it is only for rendering the image (or animation, or video) and it does not include the underlying data upon which the visualization graphic data was based when the visualization was constructed from the underlying data. In other words, in this embodiment, program 240 does not have access to the data used to construct the visualization in the first instance.

Processing proceeds to step S310 where receive guide to understanding mod 410 receives data corresponding to a guide for understanding the visualization previously received at step S305. Alternatively, this guide for understanding could be received as metadata in the file(s) of the graphic data received at step S305. In this embodiment, the guide to understanding includes a human understandable version of the guide to understanding (for example, a .txt format file with natural language narrative text explaining how to interpret the visualization. Alternatively, step S310 may be omitted entirely in some embodiments.

Processing proceeds to step S315 where receive rules mod 415 receives a set of machine readable and machine logic applicable rules for interpreting the visualization graphic. Alternatively, this set of interpretational rules could be received as metadata in the file(s) of the graphic data received at step S305. These rules allow the visualization to be interpreted based on its visual features and/or characteristics, without necessary recourse to the data used to construct the visualization in the first instance. In some embodiments where step S310 is omitted, a human understandable guide for understanding is generated based, at least in part, on the set of rules received at step S315.

Processing proceeds to step S320 where interpret visualization graphic mod 420 interprets the visualization graphic based on the set of rules received at step S315 and the graphic data of the visualization image received at step S305. This interpretation is performed by machine logic (primarily software in this embodiment) and may include one or more of the following types of interpretation: (i) determining some of the input data, with more or less precision and/or granularity, used to construct the visualization in the first instance; and/or (ii) secondary characteristics based on the data used to construct the visualization in the first instance. As an example of type (ii) interpretation, assume that a rising sales line in a graph is present in the visualization. In this case the interpretation at step S320 indicates that sales are increasing over time (that is, the time derivative of sales has positive value(s) during the time period covered by the graph), even though the graph was merely constructed based entirely on weekly sales data numbers and did not include rate of change data.

Processing proceeds to step S325 where insight logic mod 425 uses machine logic (primarily software in this example) to determine insights (for example, business-related insights) based upon the interpretation of step S320. An example of business insights based on visualization interpretation will be discussed, below, in connection with step S330.

Processing proceeds to step S330 where display mod 430 displays the visualization and a “summary of the visualization.” Alternatively, the presentation of the summary could be made in a form other than a visual display (for example, an audio presentation). As a further alternative, the summary of the visualization may be displayed separately (for example, on a separate screen, under a separate tab) from the visualization itself. The “summary of the visualization” includes at least one of the following: (i) a guide for a user in interpreting the visualization; (ii) a machine-logic generated interpretation of at least one portion of the visualization; and (iii) insight information based, at least in part, on a machine-logic generated interpretation of the visualization.

Referring now to FIG. 4, an example of a visual presentation of a visualization and an associated summary of the visualization will be discussed with reference to window 502 of screenshot 500. The upper half of window 502 is the visualization, which includes three shapes (no separate reference numerals) with each shape having an individual's name printed inside the shape. In this example, the lower half of window 502 is a summary of the visualization including, in this embodiment, all of the following: (i) a guide for a user in interpreting the visualization; (ii) a machine-logic generated interpretation of at least one portion of the visualization; and (iii) insight information based, at least in part, on a machine-logic generated interpretation of the visualization. The guide for understanding is self-explanatory. With regard to the “Interpretation of the Visualization” section, note that this is determined by machine logic based upon the rule set and the graphic data. In other words, in this embodiment, software identifies the triangle, rectangle and circle shapes, and can also roughly determine age based upon the area of each individual's associated shape. With regard to the “Insights” section of the summary of the visualization, note that the recommendations of possible commercial product and service interest areas is not based exclusively on the data used to construct the visualization, but further requires additional data and processing to determine the insight information.

### III. Further Comments and/or Embodiments

Some embodiments of the present invention generate, for the user, meaningful summary information derived from a visualization (or the data upon which the visualization is based) to help the user deal with the complexity now often encountered in visualizations. This summary information can be presented as: (i) text; (ii) sound (iii) video; and/or (iv) any other human-understandable communication channel (now known or to be developed in the future). Moreover, the human interpretation of a visualization can be verified with the summary information to catch any mistakes made in the visualization. Sometimes it may even be easier to go through the generated information summary rather than spend the time analyzing the visualization itself. Visualizations are often effectively used to support fast decision-making in domains such as business analytics, where charts represent complex business scenarios. In some embodiments of the present invention, the generated information summary facilitates fast decision making where the visualization may be too complex to be quickly understood.

Some embodiments of the present invention may have one, or more, of the following features, advantages and/or characteristics: (i) summarize information conveyed by an entire chart; (ii) support analysis, or interpretation, of chart data by providing meaningful summary information for a given business case; (iii) are applicable to static charts generated via a charting engine; (iv) communicate meaningful summary information captured during chart generation process itself; and/or (v) communicate dynamic summary information that changes with changing data and varying analysis rules (described in more detail below).

Some embodiments of the present invention include a charting engine that receives customizable user specifications, such as user display-related preference data. Examples of possible user-customizable specifications may include: (i) preferred chart type (pie, column, bar, etc.); (ii) language preference; and/or (iii) preferred file format for graphics, documents, slide shows and the like. Some embodiments of the present invention include a rules engine that interprets and processes a configurable rules file. In some embodiments, these rules may be chosen and/or provided by the user (see definition, below, in Definitions sub-section). In some embodiments of the present invention, the rules engine is coupled with the original charting engine.

Some embodiments of the present invention generate an interactive visualization, called a “visualization board,” which may be: (i) a java application; (ii) a web browser; or (iii) any other suitable platform (now known or to be developed in the future). Some embodiments of the present invention provide the user with an option on the visualization board to generate a summary of the visualization, which, when selected, generates the information summary in the format specified in the rules file with respect to text, video, sound, etc.

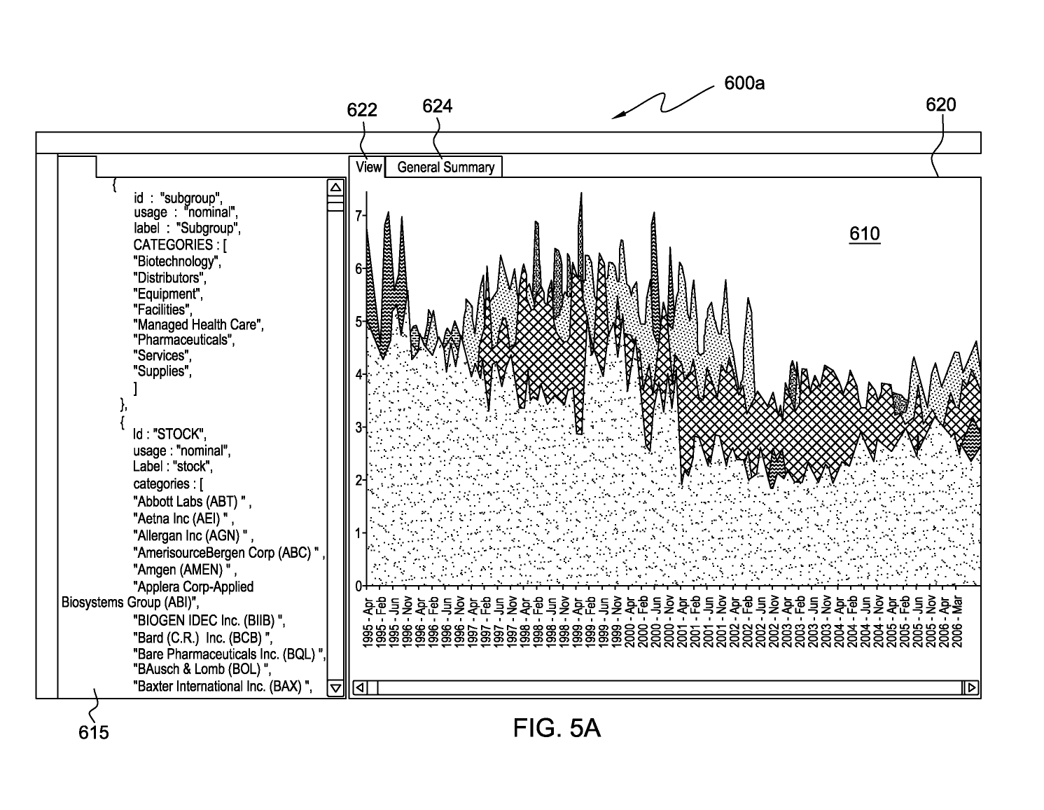

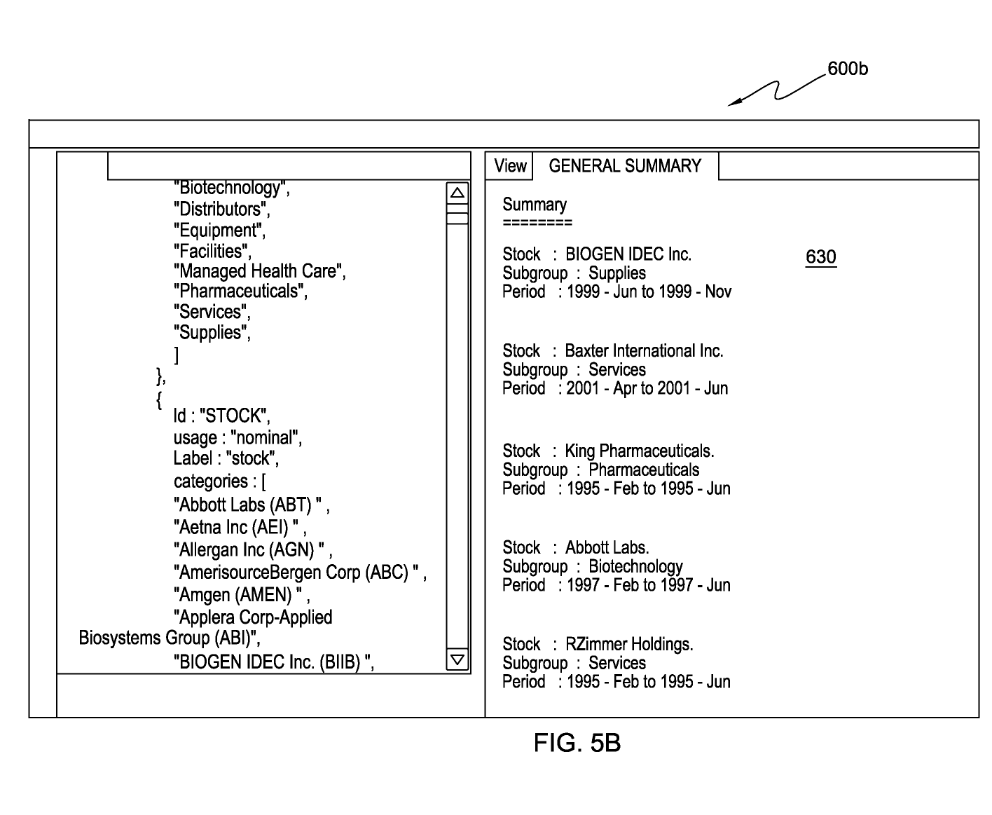

FIGS. 5A and 5B show a visualization board (built with java.awt) 600a, 600b according to one embodiment of the present invention. At a first point in time, visualization board 600a includes area chart 610 depicting the variation of healthcare stocks for a period from 1995 to 2006. Left pane 615 contains the user specification as described above and right pane 620 includes two tabs: (i) view 622; and (ii) generate summary 624. The view tab (FIG. 5A) shows area chart 610 generated by the charting engine. At a second point in time and in response to user input, the visualization board changes in appearance to become visualization board 600b, which now includes information summary display portion 630. Display portion 630 is in text format according to the input rules processed by the rules engine (not separately shown). In this example, the text-based summary stock names along with their respectively associated categories and peak share value dates.

In embodiment 600a, b, the visualization is displayed and/or interacts with the user in a manner determined by the rules engine (not separately shown). As an example of this, in chart 610 of visualization board 600a, stock price is plotted on the y-axis against time period, which is plotted on the x-axis. The stock name is mapped to identification code (id)=“stock” and the subgroup is mapped to id=“subgroup.” The rule is as follows:

<Rule>

<Display>
<Text> Summary </Text>

<Content>

<Text> Stock : </Text>
<Variable> stock</Variable>
<Text> Subgroup : </Text>
<Variable> subgroup</Variable>
<Text> Period : </Text>
<Variable> period

<Condition> max(stock price)</Condition>

</Variable>

</Content>

</Display>

</Rule>

In the above rule, the rules specify that the information summary will include the corresponding maximum value of the stock price.

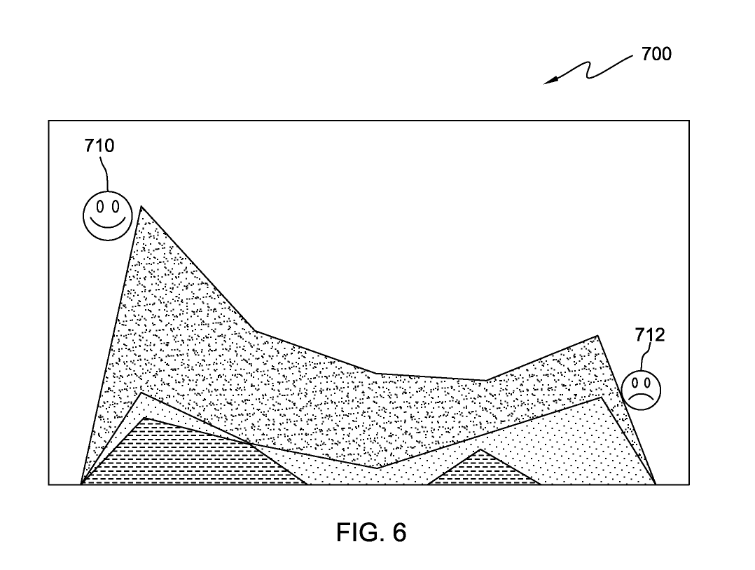

Some embodiments of the present invention provide the basic “sentiment” of the data represented in the visualization. In FIG. 6, the sentiment is shown directly on chart 700 with happy emoticon 710 and sad emoticon 712. The emoticon or similar image strongly relates to the sentiment for a given portion of the chart. In the illustrated example, the upward trend is identified as being good by placement of the happy emoticon, while the downward trend is identified as being bad by placement of the sad emoticon. The summary of the chart generated according to user specified rules can be used to show the basic sentiment/emotion of the chart, or a portion thereof. This provides a quick way for the user to see which part of the visualization is “happy” and which part is “sad”. It would essentially show that, in the case of revenue, if it is going up, it is a “happy” scenario and, in the case of the number of products returned, if it is going up, it is a “sad” scenario. The indication of sentiment may be related to a part of the visualization or the complete chart. Emoticons quickly attract the attention of the user and can provide focus to areas of particular interest so that those areas can be analyzed further.

Some embodiments of the present invention provide rules that include one or more of the following: (i) mathematical calculations; (ii) scientific calculations; (iii) logical calculations; (iv) a link to pre-created template file(s), containing valid sentences, which will be filled in with appropriate data to generate an information summary; (v) a link to the language grammar syntax rules; (vi) a link to language dictionaries; (vii) a link to domain dictionaries; (viii) a link to an image and/or emoticon file; (ix) a link to a sentence generator system; and/or (x) any other system, now existing or in the future, that dynamically helps to produce valid sentences of a given language. Some embodiments of the present invention provide rules where there is a meta-rule that defines which rule-set is to be used for summary generation based on the following: (i) type of data present in visual condition; (ii) type of user accessing the visualization; and/or (iii) any other rule.

Some embodiments of the present invention have one, or more, of the following features, characteristics and/or advantages: (i) one or more sets of rules for a given visualization for generating a meaningful information summary; (ii) rules for generating a meaningful information summary based on various categories and measures of visualization, but independent of specific values; (iii) allow the user to replace one set of rules with another set of rules at run-time to generate an altogether different information summary as desired; (iv) summarizes the important information conveyed by the entire complex chart (for example, an information summary, for a graphical chart representing flight schedules, explains that the size of certain colored circles represent the amount of traffic congestion); (v) helps in analyzing and interpreting meaningful information for a given business case; (vi) carries out analysis for multiple charts based on the rules which would otherwise be tedious if done manually; (vii) helps in verifying the human interpretation of chart and catch mistakes by comparing with the summary; (viii) saves time which was not possible if the chart would have been analyzed manually; (ix) facilitates faster decision making; and/or (x) helps a novice user who is unaware of visualization jargon to understand a chart.

If analysis is not needed, that is, if no rules are defined for analysis, the information summary can simply consist of some further description of the chart such as: (i) the meaning of circle size in a bubble chart; (ii) the representation of shapes in some given color or shading style; and/or (iii) visualization-related information such as the names of the CEO of the company over the time period that the data represents.

Some embodiments of the present invention include a “rules-based” charting engine that takes actions including: (i) performing all possible statistical calculations on all the numerical dimensions; (ii) relating the statistics to all categorical values; and/or (iii) producing an exhaustive summary for interpreting the chart.

In some embodiments of the present invention, the charting engine: (i) reads data; (ii) creates shapes based on a user specification (such as interval, bar column, etc); (iii) applies the rules specified in the rules input file to each shape generated; and/or (iv) updates the summary information.

Some embodiments of the present invention apply the rules on multiple charts when shapes for each of the charts are created by the charting engine. For example, the rules engine receives a group of shapes for a chart of volume over time and a chart of price over time and presents to the user which stocks are of interest based on defined criteria.

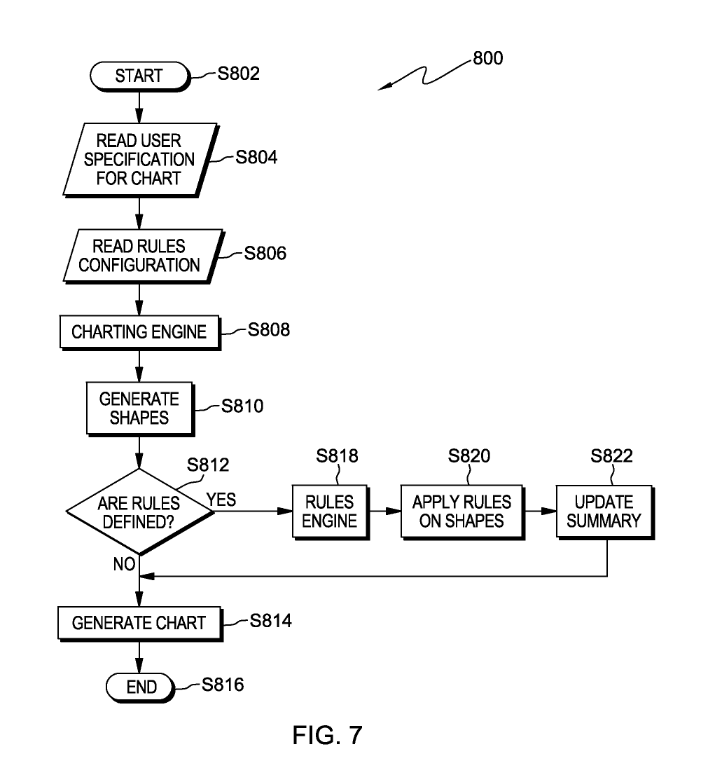

As shown in FIG. 7, process 800 generates an information summary for a chart in accordance with an embodiment of the present invention. The various steps of process 800 will now be discussed in turn.

The process 800 begins at step S802 and proceeds to step S804, where the charting engine reads the user specification.

After step S804, processing proceeds to step S806, where the rules engine reads the configurable rules file.

After step S806, processing proceeds to step S808, where the charting engine receives: (i) user specifications as input including: (a) data; and (b) other information, such as chart type (pie, column, bar etc).

After step S808, processing proceeds to step S810, where the charting engine creates shapes based on a user specification (such as interval, bar column, etc).

After step S810, processing proceeds to step S812, where the program determines whether there are any defined rules. If no rules are defined, processing proceeds to step S814, where charting engine updates the summary information. After step S814, processing ends at step S816.

If rules are defined, processing proceeds to step S818, where the rules engine (i) interprets the rules as defined; and/or (ii) processes the rules as defined.

After step S818, processing proceeds to step S820, where the rules engine applies the rules to each shape generated by the charting engine.

After step S820, processing proceeds to step S822, where the rules engine updates the summary information.

After step S822, processing proceeds to step S814, where the chart engine adds the summary information to the chart in a format as defined by the rules. After step S814, processing ends at step S816.

Some embodiments of the present invention recognize that some of the aspects that make a visualization complex and difficult to analyze are: (i) visualizing huge data (for example, stocks are charted in some cases for over 100 years, so analyzing stock data to deduce which CEO had the best stock performance over that last 100 year period is a challenge); (ii) visualizing multiple charts at one time to explain a business scenario; (iii) domain specific charts that do not make sense to the casual observer.

Some embodiments of the present invention recognize that sometimes even the simplest visualization does not explain everything. For example, it is not trivial for a bar chart or pie chart to compare multiple values. In the case of pie charts, one cannot figure out which slice of the pie is bigger in cases where slices are almost the same size. Accordingly, it is not always possible for a visualization to convey its essence at a single glance and might involve tedious efforts to understand. We thus need a way to convey the essence of a visualization with a summary. It is worth noting that the summary can itself be a video and/or audio visualization.

According to some embodiments of the present invention, the rules engine is also capable of receiving a visualization directly from sources other than a charting engine, such as: (i) HTTP; (ii) file sharing; and/or (iii) etc. When received from another source, the image is converted to a set of shapes for the rules engine to process. In this case, the converter may be an image processing and/or reading tool. If the visualization summary is itself a visualization the converter performs a two-step process of converting to shapes, then creating a visualization to be displayed as a new visualization. The rules engine itself is intelligent enough to take associative information from different parts of a visualization, that is, it can read legends to build the information summary.

Some embodiments of the present invention use a visualization instead of the visualization's input data for analysis, essentially performing analysis on a visualization itself. For example, a user may want to run an analysis on a chart that is retrieved from a web service call or a URL without access to the input data used to create the chart.

Some embodiments of the present invention create rules over the visualization to help a user create customized rules without knowing anything about, or even having access to, the underlying data schema. For example, there may exist a browser extension or a mobile application that allows a user to write their own rules based on a rendered chart type. Visualization-based rules, once created, will work on any other visualization (video or static) so long as it presents the same type of chart.

Some embodiments of the present invention recognize that for the same data, different charts can highlight different aspects of a system. Accordingly, some embodiments of the present invention provide for a user having rules specific to a particular visualization to assist in creating a highly customized summary that will be appropriately overlaid in the chart to help the user understand the presented information better.

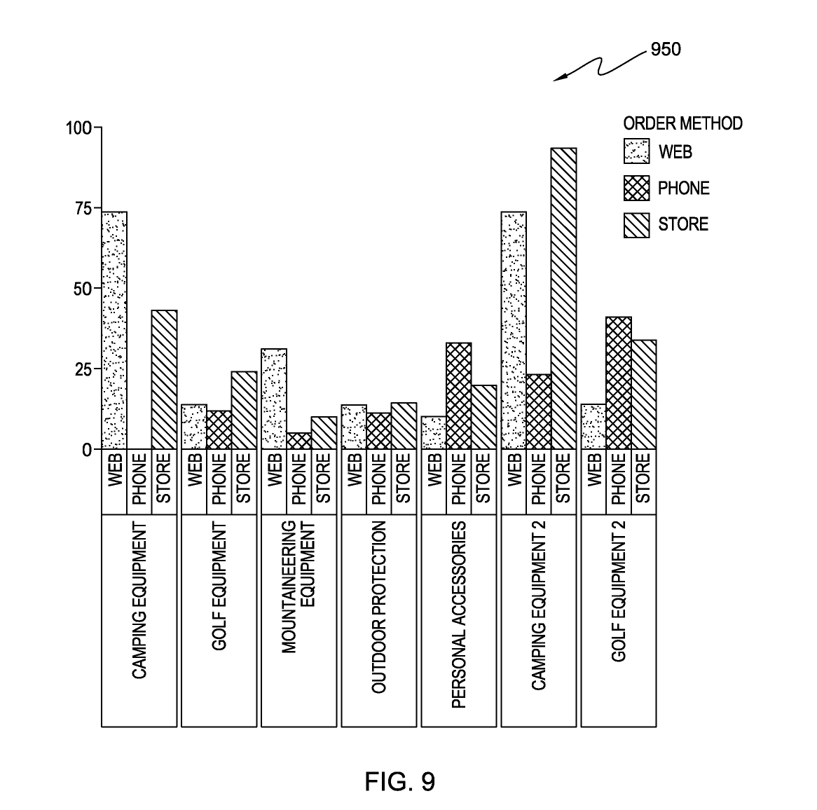

An example of a process where rules are applied to a visualization is where a cluster bar chart is the subject of analysis, as shown in bar chart 950 of FIG. 9. Process steps include: (i) the rules engine receives a cluster bar chart where each of the clusters represent a product category, such as: (a) camping equipment; (b) golf equipment; (c) mountaineering equipment; (d) outdoor protection; and (e) personal accessories, and each of the product categories has three ordering methods: (a) web; (b) phone; and (c) retail store (the chart identifies the quantity sold on the y-axis for each ordering method grouped by product category on the x-axis); (ii) the rules engine examines the cluster bar chart to identify: (a) which of the clusters show equal performance of the three order methods; (b) which of the clusters shows a single order method having a quantity greater than 50% of maximum quantity sold; (c) which of the clusters show the summarized quantity sold via three order methods greater than a threshold value defined by the rules; and/or (d) any other specified rule; and (iii) the charting engine displays the information summary either as a visualization or other format as defined by the rules.

Some embodiments of the present invention are suitable in cases of visualization engines based on grammar of graphics.

Some embodiments of the present invention summarize a visualization to bring on-demand insight from a visualization itself.

Some embodiments of the present invention do not couple the rules engine to a particular visualization engine. Each charting engine (on same or different platform such as web, mobile, or desktop) generates platform-specific shapes that are used to build the visualization. These shapes are converted by a converter (implemented by the charting engine) to shapes that the rules engine can understand for building the visualization summary. The rules engine defines a format, for shapes to be accepted from the charting engine. The converted shapes contain, for example: (i) the shapes for axes; (ii) the axes min and max values; (iii) the shapes representing visualization data or (iv) contextual information about the shapes, such as the type of chart, for example: (a) bar; (b) cluster; (c) point; (d) bubble; and (e) line.

Some embodiments of the present invention provide a rules engine that can receive a visualization directly from sources other than a charting engine, such as: (i) HTTP; (ii) file sharing; and/or (iii) etc. When received from another source, the image is converted to a set of shapes for the rules engine to process. In this case, the converter may be an image processing and/or reading tool. If the visualization summary is itself a visualization, the converter performs a two-step process of converting to shapes, then creating a visualization to be displayed as a new visualization. The rules engine itself is intelligent enough to take associative information from different parts of a visualization, that is, it can read legends to build the information summary.

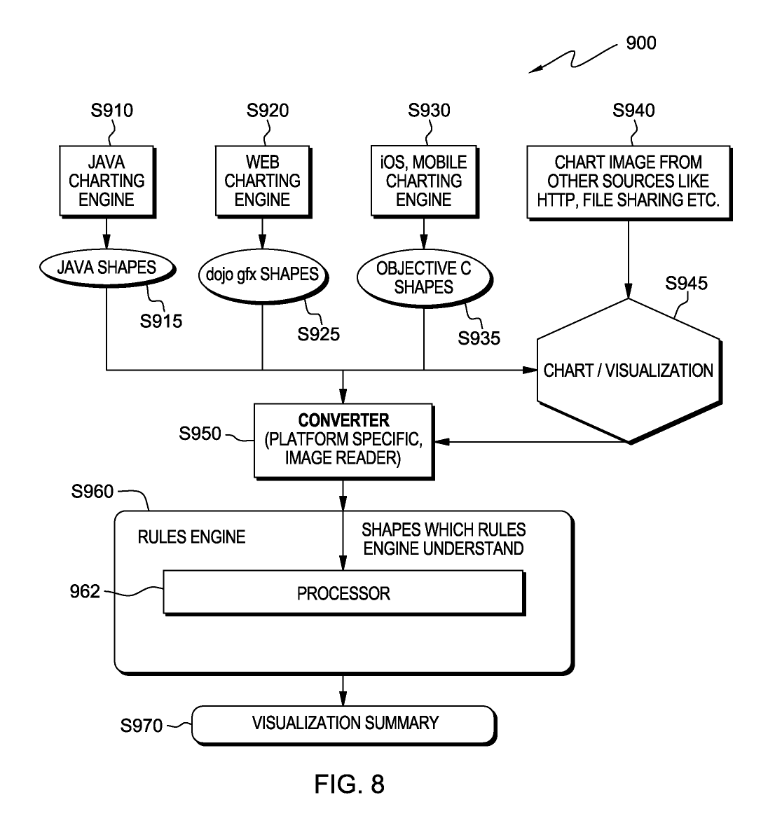

As shown in FIG. 8, process 900 is one possible process for generating an information summary for a chart in accordance with an embodiment of the present invention. The various steps of process 900 will now be discussed in turn.

The process 900 begins at step S910 where the Java charting engine reads the user specification, when available.

After step S910, processing proceeds to step S915, where Java charting engine creates Java shapes based on the user specification.

After step S915, processing proceeds to step S920, where web charting engine reads the user specification, when available.

After step S920, processing proceeds to step S925, where web charting engine creates shapes, including dojo and/or gfx forms, based on the user specification.

After step S925, processing proceeds to step S930, where mobile charting engine reads the user specification, when available.

After step S930, processing proceeds to step S935, where mobile charting engine creates objective C shapes based on the user specification.

After step S935, processing proceeds to step S940, where rules engine receives a chart image directly from sources other than charting engines, when available, including: (i) hypertext transfer protocol (HTTP); (ii) file sharing; and/or (iii) etc.

After step S940, processing proceeds to step S945, where the rules engine reads the chart image including associated legends, etc. for use in creating a visualization summary.

After step S945, processing proceeds to step S950, where the converter module converts the shapes created by a charting engine (see steps S915, S925, and S935) or received directly by rules engine (see step S940) to shapes that the rules engine can understand for building the visualization summary. For example, some shapes created by the charting engine are converted to pre-defined shapes for axes and/or min/max values.

After step S955, processing proceeds to step S960, where rules engine processor 962 builds a visualization summary based on the shapes input from the converter module.

After step S960, processing proceeds to step S970, where the visualization summary is displayed on a display device.

Some embodiments of the present invention may be adopted in business analytics to analyze complex charts for faster decision making because of the capability of capturing particular trends or sentiments when the visualization represents large data.

Some embodiments of the present invention provide a rules engine that analyzes multiple visualizations at once and derives a logical conclusion from them based on the rules specified. The rules engine receives a combination of visualizations such as a chart of volume over time and a chart of price over time and presents to the user which stocks are of interest based on defined criteria.

Some embodiments of the present disclosure use “shapes information” and come up with a text summary. The shape definitions may be expressed in any declarative shape definition format (now known or to be developed in the future).

Some embodiments of the present disclosure provide insight. For example, considering the nature of charting engines where the shape definitions are available easily for computation, some embodiments may include a statistical component to highlight insights (for example, commercially available software packages for statistical analysis to provide valuable insights).

Some embodiments of the present invention may include one, or more, of the following features, characteristics and/or advantages: (i) solve the general problem of analyzing and understanding a complex visualization by working on visual element properties instead of on base data; (ii) make use of visualization specific rules that are domain agnostic; (iii) work from a set of rules to generate meaningful information summary from a visualization; (iv) convey a meaningful information summary by inspecting the visual elements automatically; (v) include automated translation and/or interpretation of digital drawings (such as adding annotations and/or drawing symbols) and generate reports; (vi) generate a meaningful information summary out of an entire visualization as a whole, rather than by selecting a part of the visualization to be analyzed against the rules; (vii) include a charting engine that generates an intermediate file (JSON or xml) that is platform independent; (viii) includes platform specific renderers (such as web, mobile, and desktop renderers) to consume an intermediary file and generate an information summary visualization; (ix) analyze charts based, at least in part, on the visual element properties (that is, the shapes created by the charting engine in a specified format); (x) represent the sentiment of the information summary by applying an emoticon to the chart, or a relevant portion thereof; and/or (xi) include a rules engine having capabilities that include (a) doing simple things such as generating meaningful summary based on the rules specified to provide a description of what to focus on in the chart, and/or (b) integrating with complex systems like software packages for statistical analysis to provide valuable insights.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: non-exclusive or; for example, A and/or B means that: (i) A is true and B is false; or (ii) A is false and B is true; or (iii) A and B are both true.

User/subscriber: includes, but is not necessarily limited to, the following: (i) a single individual human; (ii) an artificial intelligence entity with sufficient intelligence to act as a user or subscriber; and/or (iii) a group of related users or subscribers.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

What is claimed is:

1. A method of communicating information concerning a visualization, the method comprising:
receiving graphical data corresponding to a visualization;
generating a summary of the visualization; and
presenting the summary of the visualization in human understandable form and format;
wherein:
the summary of the visualization includes at least one of the following: (i) a guide for a user in interpreting the visualization; (ii) a machine-logic generated interpretation of at least one portion of the visualization; and (iii) insight information based, at least in part, on the machine-logic generated interpretation of the visualization.

2. The method of claim 1 wherein the summary of the visualization includes the guide for the user in interpreting the visualization.

3. The method of claim 1 further comprising:
processing the graphical data, by machine-based logic, to generate the machine-logic generated interpretation of at least a portion of the visualization;
wherein:
the summary of the visualization includes the machine-logic generated interpretation of at least one portion of the visualization.

4. The method of claim 3 wherein the processing is based, at least in part, on a set of rules including at least one rule.

5. The method of claim 1 further comprising:
processing the graphical data, by machine-based logic, to generate the machine-logic generated interpretation of at least a portion of the visualization; and
processing the machine-logic generated interpretation to generate insight information.

6. The method of claim 5 wherein:
the processing-the-graphical-data is based, at least in part, on a set of rules including at least one interpretational rule; and
the processing-the-machine-logic-generated-interpretation is based, at least in part, on a set of rules including at least one insight-related rule.
